(19) United States
(12) Patent Application Publication
(10) Pub. No.: US 2016/0029730 A1
(43) Pub. Date: Feb. 4, 2016

(54) S.A.T. (Spring Absorption Technology)

(71) Applicant: Sedrick Dewayne Day, Metairie, LA (US)

(72) Inventor: Sedrick Dewayne Day, Metairie, LA (US)

(21) Appl. No.: 14/833,027

(22) Filed: Aug. 21, 2015

Related U.S. Application Data
(63) Continuation-in-part of application No. 14/166,993, filed on Jan. 29, 2014.

(51) Int. Cl. A42B 3/06; F16F 3/087; F16F 3/04

(52) U.S. Cl. CPC A42B 3/06; F16F 3/04; F16F 3/0873

(57) ABSTRACT

There are many protective helmets out there. Some use single shells with air shocks. Some helmets even have a two shell helmet with air shocks or air pockets. One helmet design has a two shell helmet with extension spring alone the longitudinal axis that allows the outer shell to slide and the extension spring has to extend to be effective. All the helmets out there have a unique qualities. The S.A.T helmet has the ability to protect its participants head from all angles not just from a frontal impact with a sliding motion. The S.A.T compression springs being made of multiple materials, make it more effective in protecting its participants whether the spring compression force is weaker (i.e. for a 10 year old football league) or stronger spring (i.e. for professional racecar driver). The compression springs also embodies multiple compression zones that allow the said compression springs to compress at different forces of impact. The S.A.T helmet can be used in football helmets, as well as hockey, lacrosse, batting helmet, motor sport helmet, cycling helmet or in any protective headgear including combat helmets. The ability to have a double layer shell separated by compression spring gives it a unique ability to absorb energy more effectively than single layer helmets and helmet using extension springs. The S.A.T helmet will also comprise an interior padding member to make the helmet more comfortable and add another absorbing factor to the double layer shell.

### DETAILED DESCRIPTION

The S.A.T helmet consists of a double layer shell separated by one or more compression spring. The said layers of the shell comprise a top layer and a bottom layer. The said layers are made of but not limit to a hardened plastic or carbon fiber type material. The said top layer of the helmet has grooves in it that enable the said compression spring to screw into the said top layer of said shell joining them together. The bottom layer of the said shell has holes in them that allow the compression springs to pass through them and screw into the bottom shell and top shell simultaneously.

The main absorption factor in the shell is the use of compression springs that are used in the invention. Although the compression springs can be different sizes and shapes such as but not limited to convex, conical, cylindrical, concave, closed ended, open ended, with right or left hand helices they serve the same purpose. Said compression spring individually have its own compression force that is independent of any other said compression spring used in the helmet. Each individual said compression spring may have multiple compression zones within that same spring. Depending on the action or compression force need to achieve the desired protection the compression spring can be made from material comprised of but not limited to rubber, titanium, metal, steel, aluminum, copper, or bronze, or a combination of said materials. In this invention I have two types of compression springs. One type is the connector spring which is used to connect one layer to the other. The connecter spring has a fitting on each end lined with a thread called the spring cap used for screwing thing together. Because the connector spring are still a compression spring it still has the ability to compress when energy is applied. The connector spring passes through the bottom layer and fits in the groove of the top layer and screws into both shells at the same time. The other type of spring is the action spring which has a fitting on one end of the spring lined by the spring caps for screwing. The action springs are strategically placed according to the desired function of the shell. These spring screw into the bottom layer and don't attach to the top layer. The action spring also a compression spring and they serve as an energy absorption property throughout the helmet.

Once the double layer helmet has been joined together the compression springs work together by compressing to absorb the energy applied from the force of an object. In the event of a collision with momentum being a factor, the compression of the springs slows the momentum of the head of the user down before reaching the fully compressed limits which brings the head to an abrupt stop.

### DESCRIPTION OF PREFERRED EMBODIMENTS

FIG. 1 embodies an action spring 101. This compression spring contains at one end a fixing that has thread used for screwing thing together called the spring cap 107. The spring cap 107 can be color coded for easy assembly. The action spring 101 can be made of many different materials, such as but not limited to metal, rubber, titanium, copper, aluminum, bronze or steel. The action spring 101 can be different sizes, lengths, thickness, shapes, designs, colors, leads, or pitch. Action spring 101 may contain different compression zones within the same action spring 101. The action spring 101 has independent compression forces with each individual Action spring. FIG. 1 also embodies a connector spring 102. It has spring caps 107 on both ends. The connector spring 102 can have different material, sizes, color, shapes designs, thickness, leads, or pitch. The connector spring 102 can be made of copper, rubber, titanium, metal, steel, aluminum or bronze. The connector spring 102 can have multiple compression zones within the same connector spring 102. Each connector spring 102 compression force is assigned individually.

FIG. 2 embodies an example of connector spring 102 being passed through the bottom layer 105 and placed at the top layer 106 where a tool is used to screw the connector springs 102 to both shells at the same time, connecting them together as one being separated by compression springs.

FIG. 3 embodies an example of an action spring 101 after being screwed through the bottom layer 105 but not attached to the top layer 106.

FIG. 4 embodies an example of a bottom layer 105 with holes that have grooves inside them 108 that allow the spring caps 107 to screw to the bottom layer 105. The holes 108 are strategically placed depending on the desired function and action needed.

FIG. 5 embodies a complete view of an unassembled bottom layer 105 with strategically placed holes. 108 the holes 108 can be different sizes, shapes and placed wherever see fit to achieve individual helmet goals.

FIG. 6 embodies a transparent assemble helmet. The top layer 106 connected to the bottom layer 105 by using strategically placed connector springs 102. It also embodies strategically placed action springs 101 to the bottom layer 105. Bottom layers 105 and top layers 106 are made of carbon fiber or harden plastic.

FIG. 7 embodies a frontal view of the helmet showing a different transparent view of the action springs 101 and connector springs 102 separating the double layer shell.

FIG. 8 shows the action of the compression spring as it is being compressed from force.

FIG. 9 shows an example of a compression spring with multiple compression force zones. The action spring 101 shows a weaker compression zone for section 135 than section 130. The multiple compression zones allows different level of compression from different amounts of applied force within the same helmet

### BRIEF DESCRIPTION OF THE DRAWING

FIG. 1

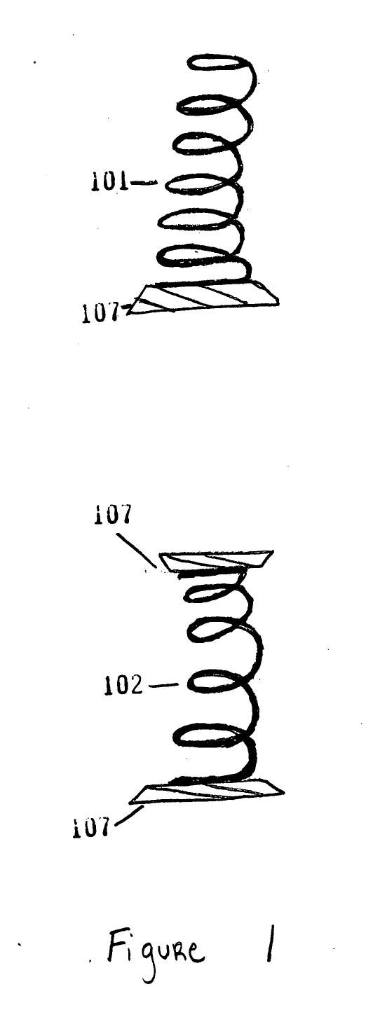

Shows an example of the two types of springs used to construct the helmet, a connector spring with spring caps, and an action spring with a spring cap.

FIG. 2

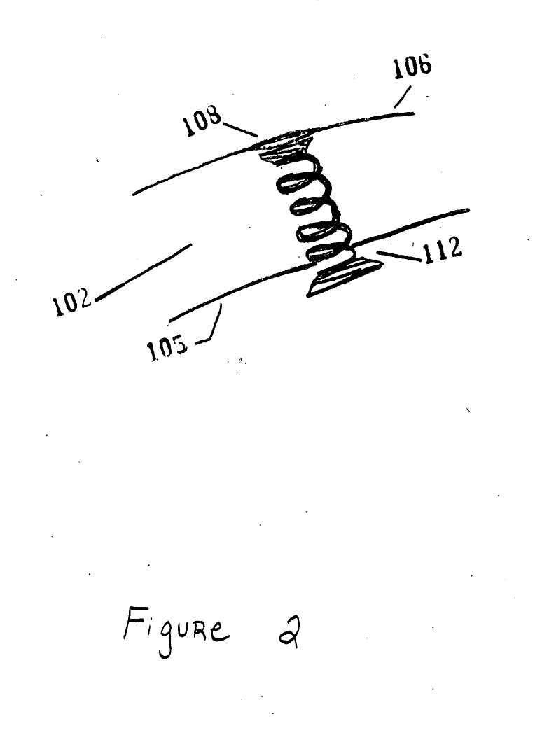

Shows an example of a connector spring being attached by screwing it into the two layer shell top layer and bottom layer with a screw driver.

FIG. 3

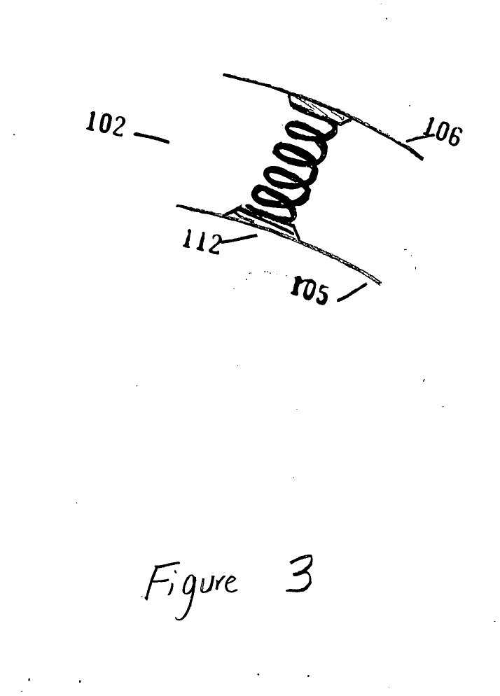

Shows an action spring screwed into the double layer shell not connecting to the top shell.

FIG. 4

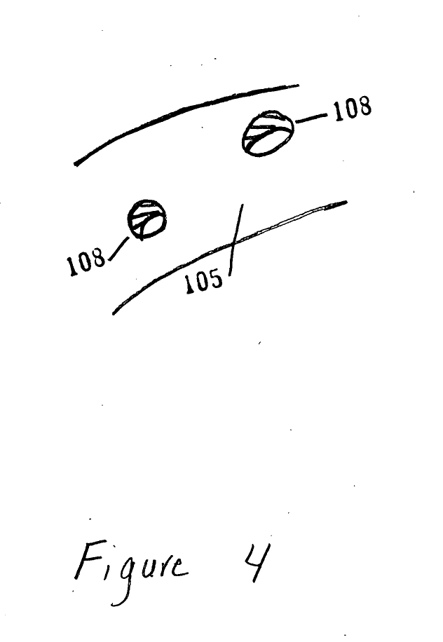

Shows an example of a bottom layer with holes which allows the compression springs to come through and then screw in using the threads on the inside of the holes.

FIG. 5

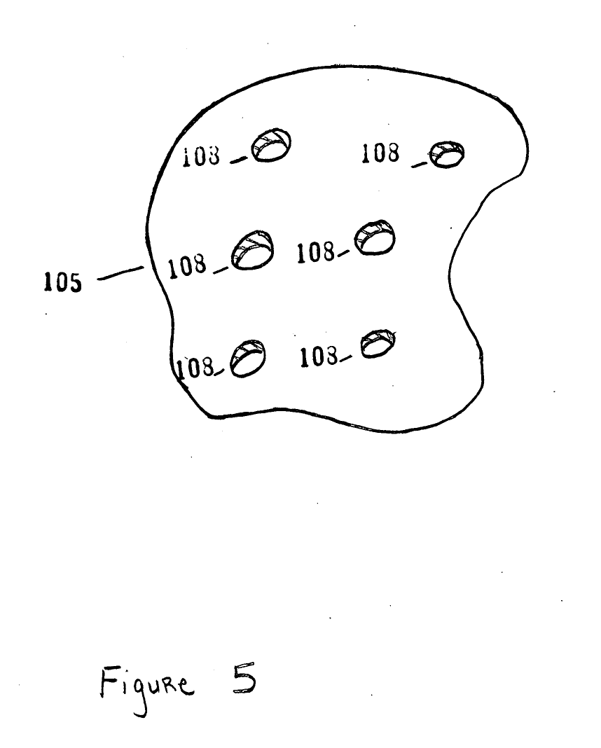

Shows an example of a bottom shell before it is assembled and before the compression springs are attached.

FIG. 6

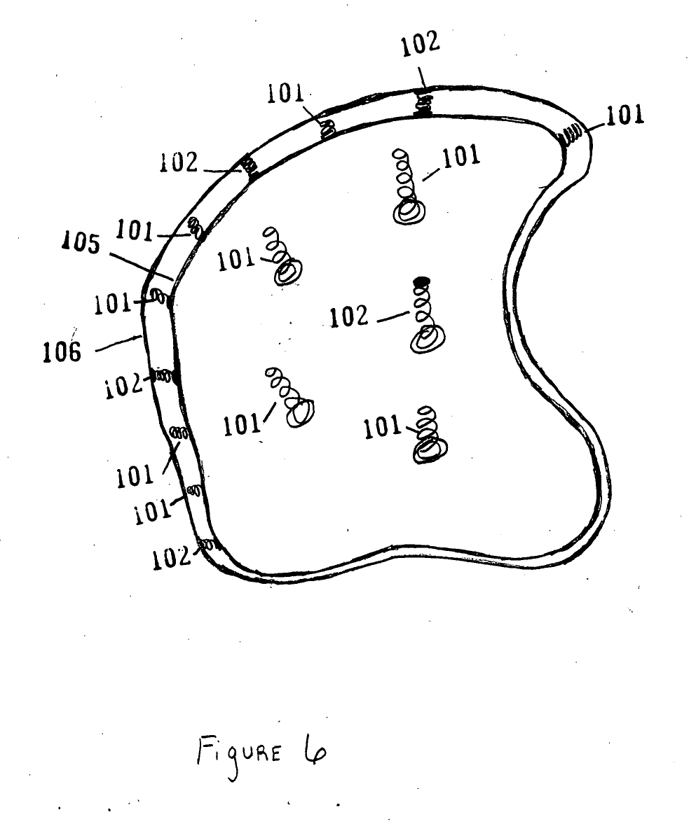

Shows a transparent cross-sectional view of an assembled double layer shell with strategically placed compression springs.

FIG. 7

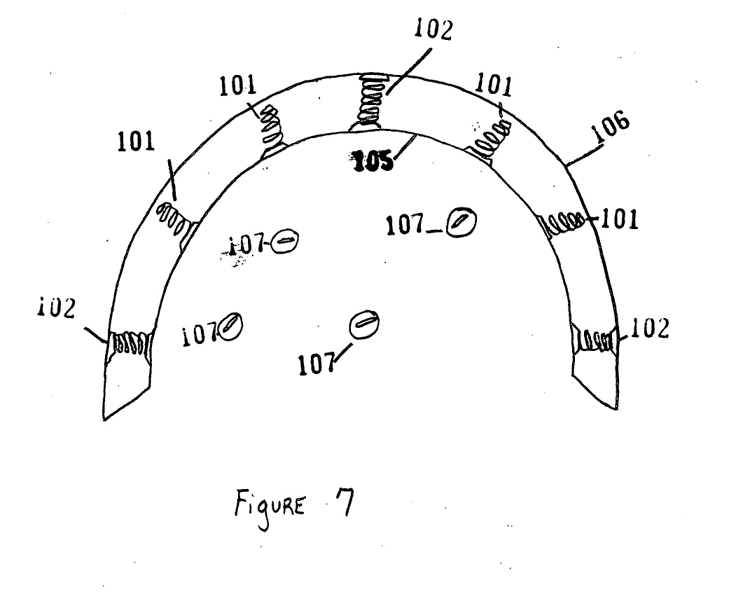

Shows a transparent frontal view of the double layer shell with compression springs placed strategically throughout the shell.

FIG. 8

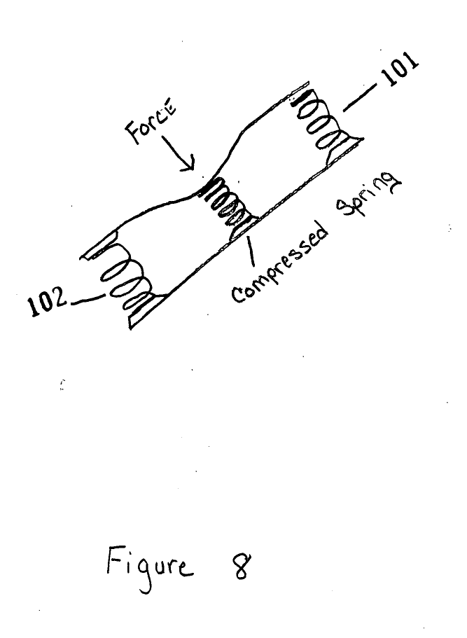

Shows the compression action of a compression spring once force is applied to one side of the shell.

FIG. 9

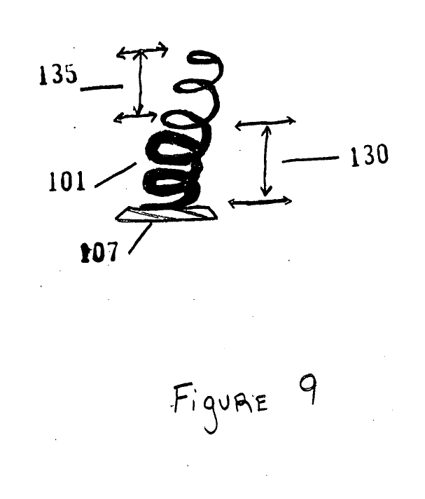

Shows an example of a compression spring with multiple compression zones.

### BACKGROUND

Protective helmets have been around for a long time. Head injuries have become a more serious issue lately. We as parents, fans, and participant of sports and other active activities that use helmets are more aware of the importance of good head protective gear. Providing young kids whose brains are still developing with better helmet than what we currently have is very important and in high demand. Using compression springs with different compressing forces made of different materials and having the ability to be made with a combination of material and having the double layered shells made of a lighter materials such as carbon fiber is a huge step in the right direction. Compression spring with compression zones have never been used in the magnitude and design that my helmet offers and will be a big upgrade to currently available selections.

1. The S.A.T helmet comprised of a double layered shell separated by one or more compression spring(s). The said compression springs serves as the primary energy absorption matter of the shell upon applied force. The S.A.T helmet of claim 1 further comprises a padded member to the inner surface of the shell. The S.A.T helmet of claim 1 further comprises said compression spring(s) of different sizes, which are independent from each said compression spring(s) allowing each spring in the shell to have its own individual sizes. The S.A.T helmet of claim 1 further comprises said compression spring(s) with different compression forces which are independent to each individual said compression spring(s) used in the shell. The S.A.T helmet of claim 1 further comprises said compression spring(s) made of different material such as but not limited to rubber, metal, titanium, steel, aluminum, copper, and bronze. The S.A.T helmet of claim 1 further comprises said compression spring(s) with multiple compression zones within the same said compression spring(s). The S.A.T helmet of claim 1 further comprises said compression spring(s) with different pitches or leads which are independent of each said compression spring(s) The S.A.T helmet of claim 1 further comprises said compression spring(s) with different compression forces, which are independent from each other, allowing each said compression spring to have its own compression force in a said shell. The S.A.T helmet of claim 1 further comprises said compression spring(s) with different designs such as but not limit to convex, conical, cylindrical, concave, closed ended, opened ended with right or left hand helices. The S.A.T helmet of claim 1 further comprises a face protection member that includes but is not limited to face a mask for activities such as action sports or a face guard for motor sports. The S.A.T helmet of claim 1 further comprises an inner layer with one or more holes that allows the compression spring to be screwed into the inner layer of the shell. The S.A.T helmet of claim 1 further comprises an outer layer that contains one or more slots that allows the connector springs to attach the inner and outer layers together. The S.A.T helmet of claim 1 further comprises a compression spring with a spring cap that allows the spring(s) the ability to be screwed into the holes on the inner layer and the slots of the outer.
